(19) United States
(12) Patent Application Publication
(10) Pub. No.: US 2013/0036613 A1
(43) Pub. Date: Feb. 14, 2013

(54) DESEEDER AND VEGETABLE PEELER

(71) Applicant: Shelley Hollums, Midland, TX (US)

(72) Inventor: Shelley Hollums, Midland, TX (US)

(21) Appl. No.: 13/209,423

(22) Filed: Aug. 14, 2011

(51) Int. Cl. A47J 17/02

(52) U.S. Cl. 30/123.7

(57) ABSTRACT

The present invention is a deseeder and vegetable peeler with a front half and a back half that includes a handle that includes an elongated oval portion that ergonomically accommodates a user gripping the deseeder and vegetable peeler and a deseeding tool that includes an elongated scoop with a distal end and a proximal end and a double-sided vegetable peeler that is disposed on the approximate front half of the deseeder and vegetable peeler. There is also an attachment interface that attaches the handle to the back half of the deseeder and vegetable peeler and a pointed end that is utilized to puncture any vegetables or fruits that are to be deseeded or peeled with the deseeder and vegetable peeler.

### TECHNICAL FIELD & BACKGROUND

Traditional methods of deseeding vegetables such as jalopeno peppers as well as peeling vegetables require an individual to utilize more than one tool, one tool for deseeding the vegetables and another tool for peeling the vegetables. Currently, there are limited alternatives to kitchen instruments that combine these functions.

The present invention generally relates to a vegetable peeler. More specifically, the invention is a deseeder and vegetable peeler.

It is an object of the invention to provide a deseeder and vegetable peeler that can deseed and peel vegetables.

It is an object of the invention to provide a deseeder and vegetable peeler that allows a user to conveniently deseed jalopeno peppers and peel vegetables with one device that saves time.

It is an object of the invention to provide a deseeder and vegetable peeler that is made of a variety of durable materials.

What are really needed are a deseeder and vegetable peeler that can deseed and peel vegetables, that allows a user to conveniently deseed jalopeno peppers and peel vegetables with one device that saves time and that is made of a variety of durable materials.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side perspective view of a deseeder and vegetable peeler, in accordance with one embodiment of the present invention.

FIG. 1B illustrates a front perspective view of a deseeder and vegetable peeler, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

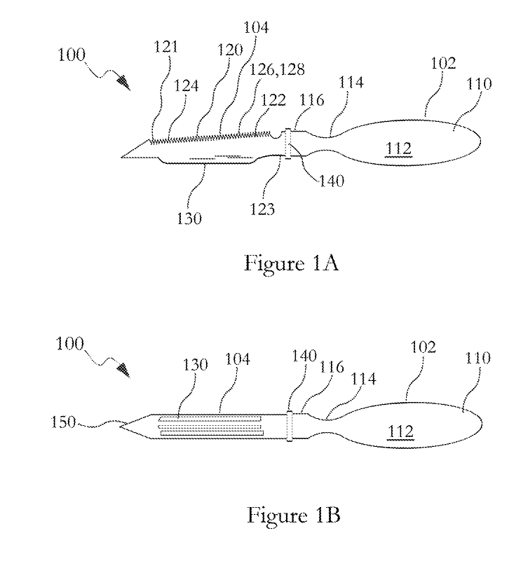

FIG. 1A illustrates a side perspective view of a deseeder and vegetable peeler 100, in accordance with one embodiment of the present invention.

The deseeder and vegetable peeler 100 includes a handle 110 and a deseeding tool 120.

The handle 110 is disposed on the approximate back half 102 of the deseeder and vegetable peeler 100 and is made of wood, porcelain or other suitable material. The handle 110 also has an elongated oval portion 112 that can ergonomically accommodate a palm of a user gripping the deseeder and vegetable peeler 100 and pinched tapered portion 114 disposed between the elongated oval portion 112 and the proximal end 116 of the handle 110. The pinched tapered portion 114 can ergonomically accommodate a user's pinched fingers for a relatively stronger grip than a conventional handle. The deseeding tool 120 is an elongated scoop 122 with a raised edge perimeter 124 with a plurality of serrated edges 126 disposed on the perimeter 128 of the raised edge perimeter 124. The serrated edges 126 can also be double-sided or any other type of suitable serrated edge. The elongated scoop 122 is approximately ½″ deep at a distal end 121 of the elongated scoop 122 and approximately ½ deep at a proximal end 123 of the elongated scoop 122 although other suitable scoop depths can be incorporated into the elongated scoop 122.

FIG. 1B illustrates a front perspective view of a deseeder and vegetable peeler 100, in accordance with one embodiment of the present invention.

The deseeder and vegetable peeler 100 includes a handle 110, a deseeding tool 120, a vegetable peeler 130, an attachment interface 140 and a pointed end 150. The handle 110 and the deseeding tool 120 of the deseeder and vegetable peeler 100 illustrated in FIG. 1A and described in the FIG. 1A description includes the handle 110 and the deseeding tool 120 as the deseeder and vegetable peeler 100 illustrated and described in FIG. 1B and its description.

The vegetable peeler 130 is a double-sided vegetable peeler that is disposed on the approximate front half 104 of the deseeder and vegetable peeler 100 underneath the deseeding tools 120. The vegetable peeler 130 can also be any other suitable vegetable peeler such as a single-sided vegetable peeler. The attachment interface 140 attaches the handle 110 to the approximate back half 102 of the deseeder and vegetable peeler 100, which can be any bolt and sleeve or other suitable attachment interface to attach the handle 110 to the approximate back half 102 of the deseeder and vegetable peeler 100. The pointed end 150 is utilized to puncture any vegetables or fruits that may be deseeded or peeled with the deseeder and vegetable peeler 100. The deseeding tool 120, the vegetable peeler 130, the attachment interface 140 and the pointed end 150 are made of stainless steel, although the deseeding tool 120, the vegetable peeler 130, the attachment interface 140 and the pointed end 150 can be made of other suitable materials.

The deseeder and veggie peeler is a kitchen utensil that enables a user to reduce time that is consumed in preparing food, especially in deseeding and peeling fruits and vegetables such as jalopeno peppers. The deseeder and veggie peeler includes a vegetable peeler on the posterior of an open-ended curved knife. The deseeder and veggie peeler has an easy-grip wooden or porcelain handle which allows the user to manipulate a serrated blade that facilitates removing seeds and veins from any pepper. The deseeder and veggie peeler will be available in various retail stores. The deseeder and veggie peeler features a sharp point at the end that is easily inserted into peppers or other vegetables and fruits. The deseeder and veggie peeler presents a ½ inch scoop at the distal end of the blade and is a valuable kitchen tool for chefs and cooking fanatics everywhere.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A deseeder and vegetable peeler with a front half and a back half, comprising:
a handle with a proximal end disposed on said front half;
a deseeding tool that includes an elongated scoop with a distal end and a proximal end;
a vegetable peeler that is disposed on said approximate front half of said deseeder and vegetable peeler;
an attachment interface that attaches said handle to said front half of said deseeder and vegetable peeler; and
a pointed end that is utilized to puncture any vegetables or fruits that are to be deseeded or peeled with said deseeder and vegetable peeler.

2. The peeler according to claim 1, wherein said handle includes an elongated oval portion that ergonomically accommodates a user gripping said deseeder and vegetable peeler.

3. The peeler according to claim 1, wherein said handle includes a pinched tapered portion disposed between said elongated oval portion and said proximal end of said handle to accommodate said user's pinched fingers.

4. The peeler according to claim 1, wherein said deseeding tool includes a raised edge perimeter with a plurality of double serrated edges disposed on said raised edge perimeter.

5. The peeler according to claim 1, wherein said vegetable peeler is a double-sided vegetable peeler.

6. The peeler according to claim 1, wherein said vegetable peeler is disposed underneath said deseeding tools.

7. A deseeder and vegetable peeler with a front half and a back half, comprising:
a handle with a proximal end disposed on said front half that includes an elongated oval portion that ergonomically accommodates a user gripping said deseeder and vegetable peeler;
a deseeding tool that includes an elongated scoop with a distal end and a proximal end;
a double-sided vegetable peeler that is disposed on said approximate front half of said deseeder and vegetable peeler;
an attachment interface that attaches said handle to said front half of said deseeder and vegetable peeler; and
a pointed end that is utilized to puncture any vegetables or fruits that are to be deseeded or peeled with said deseeder and vegetable peeler.

8. The peeler according to claim 7, wherein said handle includes a pinched tapered portion disposed between said elongated oval portion and said proximal end of said handle to accommodate said user's pinched fingers.

9. The peeler according to claim 7, wherein said deseeding tool includes a raised edge perimeter with a plurality of double serrated edges disposed on said raised edge perimeter.

10. The peeler according to claim 7, wherein said vegetable peeler is disposed underneath said deseeding tools.

11. The peeler according to claim 7, wherein said handle is made of wood.

12. The peeler according to claim 7, wherein said elongated scoop is approximately ½″ deep at said distal end.

13. A deseeder and vegetable peeler with a front half and a back half, comprising:
a handle with a proximal end disposed on said front half that includes an elongated oval portion that ergonomically accommodates a user gripping said deseeder and vegetable peeler;
a deseeding tool that includes an elongated scoop with a distal end and a proximal end;
a double-sided vegetable peeler that is disposed on said approximate front half of said deseeder and vegetable peeler;
an attachment interface that attaches said handle to said front half of said deseeder and vegetable peeler; and
a pointed end that is utilized to puncture any vegetables or fruits that are to be deseeded or peeled with said deseeder and vegetable peeler.

14. The peeler according to claim 13, wherein said handle includes a pinched tapered portion disposed between said elongated oval portion and said proximal end of said handle to accommodate said user's pinched fingers.

15. The peeler according to claim 13, wherein said deseeding tool includes a raised edge perimeter with a plurality of double serrated edges disposed on said raised edge perimeter.

16. The peeler according to claim 13, wherein said vegetable peeler is disposed underneath said deseeding tool.

17. The peeler according to claim 13, wherein said handle is made of wood.

18. The peeler according to claim 13, wherein said handle is made of porcelain.

19. The peeler according to claim 13, wherein said elongated scoop is approximately ½ inch deep at said distal end.

20. The peeler according to claim 13, wherein said elongated scoop is approximately 1 inch deep at said proximal end.
